(19) United States
(12) Patent Application Publication
(10) Pub. No.: US 2016/0317909 A1
(43) Pub. Date: Nov. 3, 2016

(54) GESTURE AND AUDIO CONTROL OF A PINBALL MACHINE

(71) Applicant: Barry Berman, Santa Ana, CA (US)

(72) Inventor: Barry Berman, Santa Ana, CA (US)

(21) Appl. No.: 15/053,860

(22) Filed: Feb. 25, 2016

Related U.S. Application Data
(60) Provisional application No. 62/155,057, filed on Apr. 30, 2015.

(51) Int. Cl. A63F 7/02; G06F 3/16; G06F 3/01; H04R 29/00

(52) U.S. Cl. CPC A63F 7/027; H04R 29/004; G06F 3/167; G06F 3/017

(57) ABSTRACT

A pinball machine includes sensors that can detect body and hand gestures and react based thereupon. These reactions can be graphical images and/or animations that are shown on a display, changing physical game play by affecting the ball's behavior or playfield, or influencing player behavior by changing rules and modes within the game. The sensors are proximal to an upright display of the machine, and/or also proximal to the front of the machine on a generally horizontal play surface thereof, and/or in front of the machine, and/or on the sides of the machine, near the physical buttons called flipper buttons. The images and gameplay appear to interact with the gestures of, or sound emanated from, the player, thereby enhancing the gaming experience. The sensors may record the player performing the gesture, and create a mask to be used within the game in the form of video animations and/or composites.

### CROSS REFERENCE TO RELATED APPLICATIONS

This application is a non-provisional of Application No. 62/155,057, filed Apr. 30, 2015, now pending and incorporated herein by reference in its entirety.

### FIELD OF THE DISCLOSURE

This disclosure relates generally to pinball games, and more specifically to hand and body gesture, as well as voice based, control of pinball machines.

### BACKGROUND

A pinball machine typically includes an inclined playfield housed inside a cabinet. The playfield supports one or more balls (pinballs) and a multitude of mechanical and electronic elements that can interact with the balls to permit scoring of points, activate different features of the game, make noises, and more. Toward the back of the machine, a vertically oriented backbox typically houses one or more displays, audio speakers, decorative artwork. The backbox may contain game control circuitry such as power supplies, processing units, memory, and other electronic components to control lighting, sound and other items. The display used to indicate scoring and other gameplay information, is traditionally in the lower section of the backbox. A display housed by the backbox can also show static and animated graphical elements. For instance, the display can show a running total of points (score) in the game, and in response to switches or actuators on the playfield, the display (with the help of the processing unit) may display an updated score or mode.

A typical pinball machine includes two or more mechanical flippers. The flippers are usually activated using buttons on the sides of the cabinet. The flippers are typically located at the lower end of the playfield, plus sometimes extra flippers are disposed in other locations. The purpose of the flippers is to give partial control of the ball to the player, by propelling the ball away from the flipper and bottom of the playfield toward targets on the playfield. Doing so may advance game modes, score points, and enhance gameplay.

While flippers do provide a great gameplay experience, only tactile immersion is provided by the flippers, and such tactile immersion limits the amount of ways in which the player can interact with the game. Some advanced players may nudge the game, which is physically moving the game without ‘tilting’ it. In addition, there has been some advancement in pinball machine technology, in that in special modes, the buttons that control the flippers can also control certain specialized actuators, magnets, and/or video interactions when the game reaches those special modes. However, the input is still the same limiting button pushing. This can make desired input take longer and/or feel awkward.

Therefore, additional development in the area of pinball machines, player input thereto, and player feedback provided therefrom is necessary.

### SUMMARY

This invention uniquely utilizes body gestures and voice commands to advance pinball gameplay. This provide the player with a more direct and immersive gaming experience. It also provides new ways to interact with the action happening on the pinball machine playfield as well awith what is being displayed on the video display. It can additionally provide a new, efficient and intuitive way to play and input data.

This disclosure includes a pinball machine that can recognize and record gestures, using various sensors. The recorded gestures then are used in influencing gameplay and providing feedback in the form of graphical display on the machine, or in activating motors, flashing lights, increasing the score, or other game play mechanisms. Sensors located on the machine record the depth, color, and infrared of the body part making the gestures, as well as audio emanating from the player. These are then stored and decoded by the processing unit.

In accordance with a preferred embodiment, the sensors are located in the backbox and also toward the bottom of the cabinet, known as the apron. The sensors in the backbox will measure large scale gestures or gross movements, video and audio of the player at select times, and also the depth of the scene. These large scale gestures or gross movements may be full body gestures. Example gestures include ducking, dodging right or left, punching the air in front of the player, chopping the air in front of the player, picking something up, and/or other suitable gestures.

The depth sensor will also be used to create an image of the player cropped to match the shape of the player. This will isolate the player in the image for use in composites, thereby further enhancing the gaming experience. These composites can be shown on any displays of the pinball machine. These displays can be in the backbox, in the playfield, on the sides of the cabinet, or in a gameplay mechanism attached to the playfield itself. These displays can be LCD, LED, OLED, or any other technology capable of showing or projecting computer-generated graphic images and/or animations.

Audio sensors will activate at times for direct input and control of gameplay. When decoded live through the processing unit, this can be used for voice control and navigation of gameplay. This will enhance playability and immersion.

In the apron, there is another host of sensors that will be used for fine gesture control driven by the hands and fingers of the player. Some examples include making a peace sign, v for victory, scouts honor, and more. The hand gesture control can also be used for virtual typing and data entry. Fine gesture control will enhance the player's experience playing the game. All sensors can be used together for detailed full body gestures to add additional facets to game-play and control of the game.

### BRIEF DESCRIPTION OF THE DRAWINGS

Further objects, features and advantages of the present disclosure will become apparent from the following detailed description taken in conjunction with the accompanying figures showing illustrative embodiments, results and/or features of the present disclosure, in which:

FIG. 1 is a perspective view of a portion of an exemplary pinball machine according to certain exemplary embodiments of the present disclosure. This also includes a cutaway view showing parts inside the pinball machine.

FIG. 2 is an exemplary schematic chart of the interacting elements of a pinball machine, according to the present disclosure.

FIG. 3 illustrates an example of the video sensor detecting and recording from its position in the backbox of FIG. 1.

FIG. 4 is an example of the depth sensor detecting and recording from its position in the backbox of FIG. 1.

FIG. 5 is an example of combining the samples detected in FIGS. 3 and 4 to thereby create a result to be displayed on the display of FIG. 1.

FIG. 6 is an example of combining the samples detected in FIGS. 3 and 4 to thereby determine a gesture of the player to be used within the game.

FIG. 7 is an example of comparing a clip of live audio to a clip of stored audio in a library. This result is a match.

FIG. 8 is an example of comparing a clip of live audio to a clip of stored audio is a library. This result is not a match.

### DETAILED DESCRIPTION OF EXEMPLARY EMBODIMENTS

Throughout the drawings, like reference numerals and characters, unless otherwise stated, are used to denote like features, elements, components, or portions of the illustrated embodiments. Moreover, while the present disclosure will now be described in detail with reference to the figures, the scope of the present invention is not to be limited by the particular embodiments illustrated in the figures.

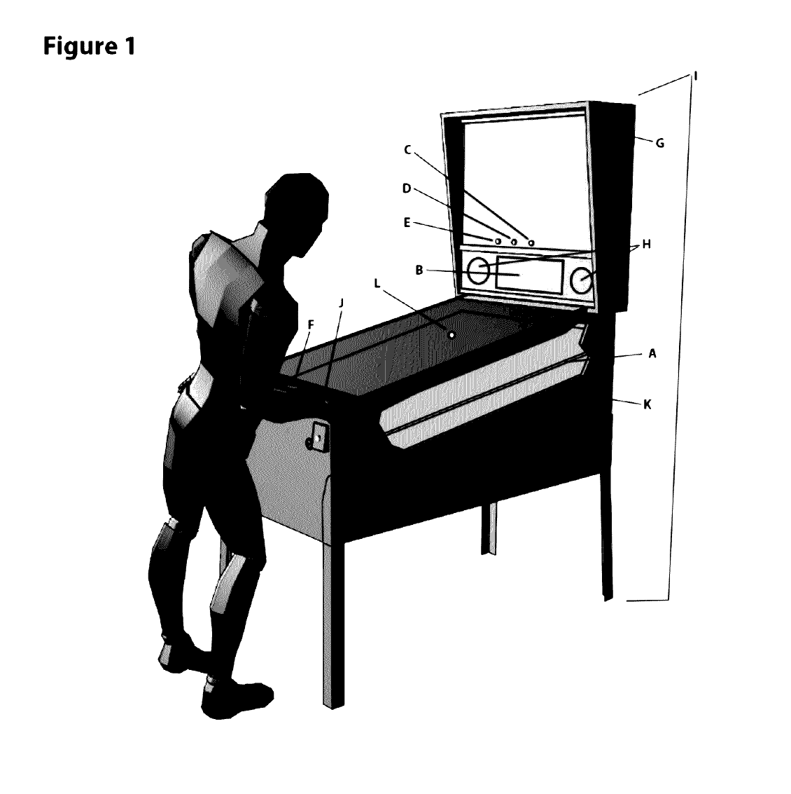

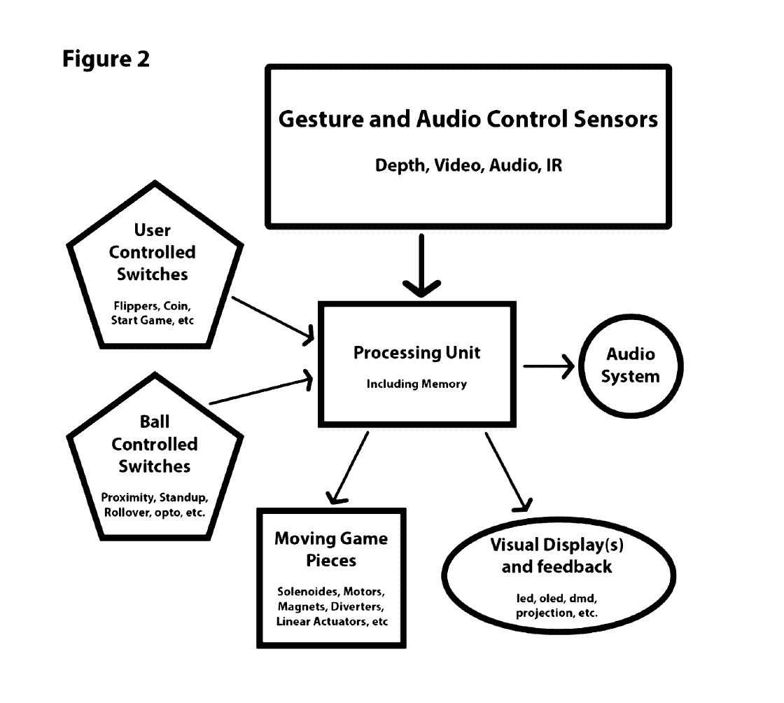

A pinball machine I in accordance with exemplary embodiments of the present disclosure is now described with initial reference to FIGS. 1-2. The pinball machine I includes a playfield surface A disposed in a game cabinet K. A backbox G is mounted over a rearward portion of the cabinet K. Game pieces (not pictured), such as pop bumpers, lane guides, saucers, spinners, standup targets, and the like, as well as one or more ramps, visual displays, or other gameplay elements can be provided on the playfield B, and one or more pinballs L can be located on the playfield. These game pieces may be moved by solenoids, motors, magnets, diverters, linear actuators, etc.

The pinball machine I includes a processing unit (shown in FIG. 2) inside the cabinet K. The processing unit will combine any input from the player generated as a gesture or audio command, or directly input as a by switch or ball, and process it accordingly. The processing unit then sends out signals causing one or more components to react to the input. This can be done by according to a rule set, and the reactions may be a score change, illumination of lighting, playback of a video animation, and/or playback of an audio queue. Indeed, any desired reaction may be performed in response to the input.

The pinball machine I includes an audio system H in the backbox and/or cabinet. This audio system H plays music and audio events based on inputs from the player as gestures or voice commands, or direct inputs from the player or ball.

The pinball machine I can include a video display B that is preferably located inside the backbox B. The video display, while primarily used for scoring information, can also display animations, video feedback, storytelling for the game, and composites generated from data read by specialized sensors in this embodiment. There may be more than one video display, located in various positions of the backbox and/or playfield. Each can do the above and will display video based on signals from the processing unit. These signals will be derived from input taken by the processing unit from player gestures or voice commands, or directly input from the player or ball.

The pinball machine I includes a host of sensors that facilitate gesture, audio E and video C, and depth D recording. These sensors are located within the backbox G mounted near the bottom of the backglass, and detect through the glass. These sensors could be located at other places in the pinball machine, and those that are skilled in the art could take advantage of further opportunities.

The processing unit executes gameplay based upon a set of game rules, and may modify that gameplay based upon input from the sensors (i.e. gesture detection). The gameplay may be modified by moving the game pieces, for example. The game rules themselves may also be changed based upon input from the sensors.

The pinball machine I also includes user controlled switches, such as flippers, coin detection switches, a start game switch, etc. In addition, the pinball machine I includes ball controlled switches that are actuated by the rolling ball, such as proximity sensors, standup switches, rollover switches, optoelectronics switches, etc.

The audio sensor E will record audio commands which will be interpreted by the processing unit. The processing unit will then give commands to other components or alter characteristics of the game. A simple example would be the phrase “Volume Up!” This phrase would be captured by the audio sensor, and then sent to the processing unit. The processing unit would analyze the phrase and compare it next to other audio pieces in its memory. The processing unit then determines that it is the phrase “Volume Up!”, and makes a correlation to the rules and behaviors within the games rule set. The processor then sends a signal to the audio system so that the audio level being output from the audio system would be raised. Countless ways to use audio commands are within the scope of this disclosure. This would include involvement with the gameplay, story, as well as settings and functions. This is a single example and should not be construed as a limiting option.

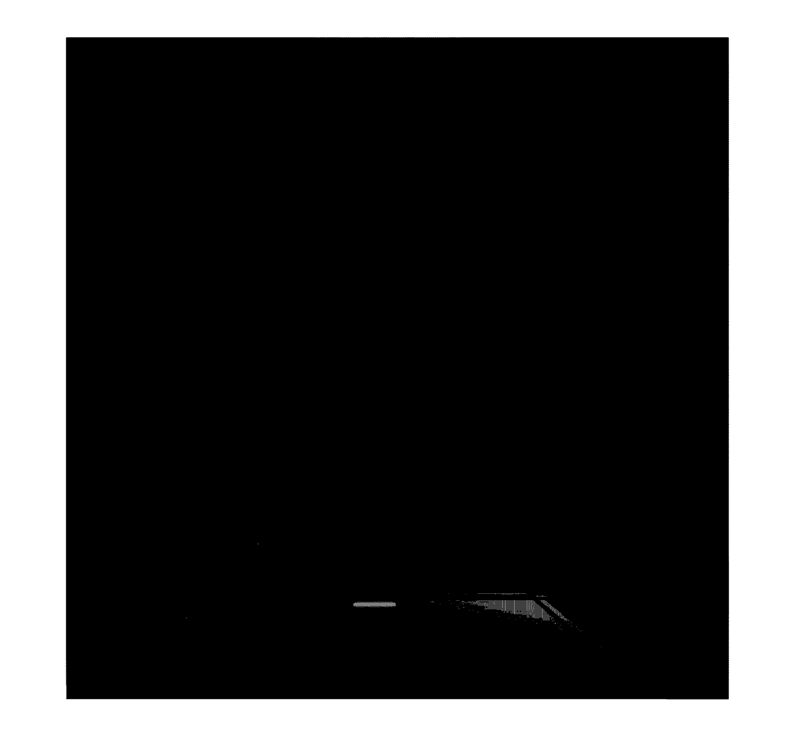

The video sensor C captures what is in front of its lens. FIG. 3 shows an exemplary illustration of a player, playing, but leaning to the left. Note that in a typical setting, there may be a room behind the character, as well as other people, objects etc. The video sensor will then send images to the processing unit and provide data so that video can be recorded and decipher gestures based on that video. The video can be combined with other data from other sensors, like the depth sensor, described below.

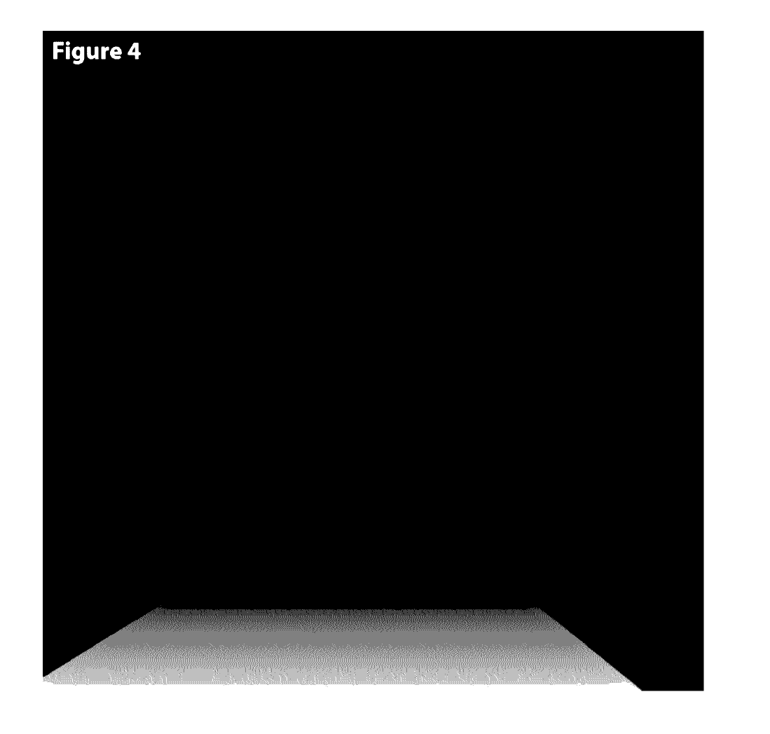

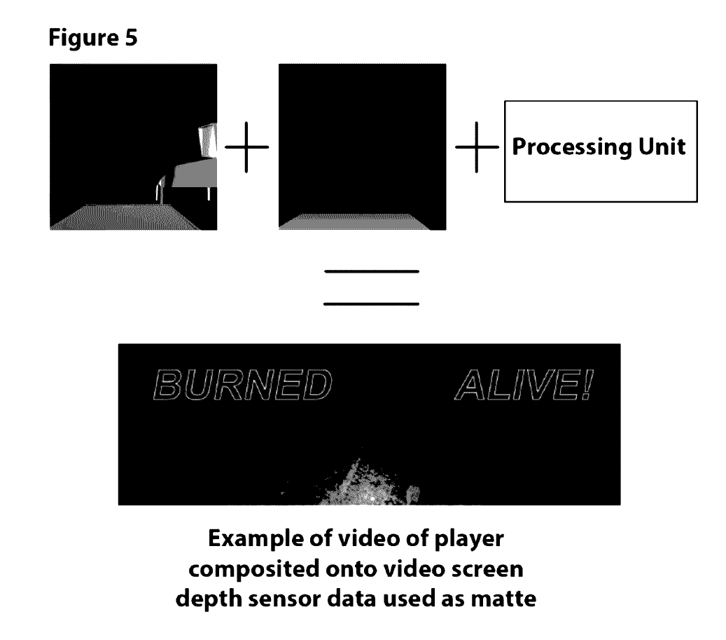

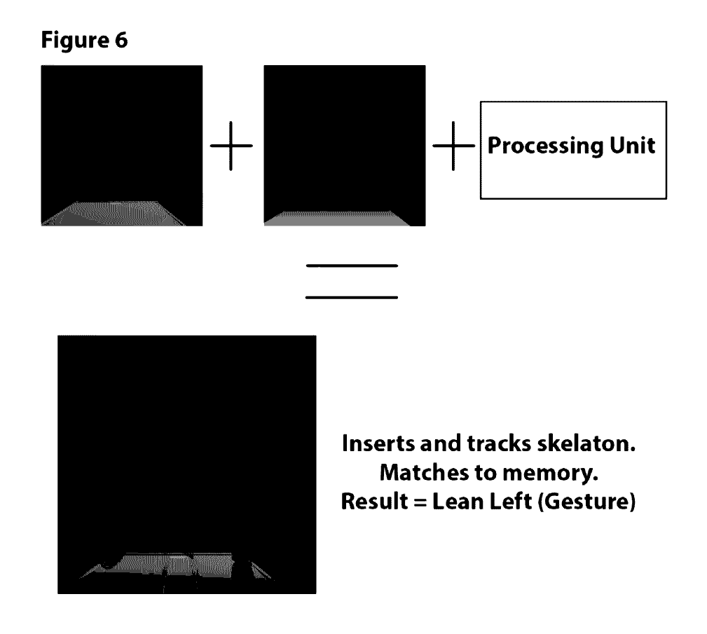

FIG. 3 shows an exemplary illustration of a player, playing, but leaning to the left. FIG. 4 shows an exemplary illustration of the same scene, except captured by a depth sensor. This measures distance from the sensor itself. This data can be used to do a many things, including creating a matte around the player and also recording gestures. FIG. 5, shows how a matte would be useful to composite the image of the player into another scene to be outputted onto a video display. FIG. 6 shows how this can also be used to derive within the processing unit the structure of the player, in this case an internal skeleton. Then the processing unit analyzes the captured data and determines if a player is performing the gesture, “leaning left”. The processing unit then checks its rules and options based on a left lean at this particular time of game play. As an example, a left lean is to avoid an obstacle on the right. In this example, this is a good thing for advancing game play. The processing unit sends a signal appropriately that a left can avoids an obstacle on the right and the player earns some points.

Coarse human body gestures include jumping, ducking, leaning. Others can be more complicated like picking an invisible lock, chopping, throwing, blocking, or casting a spell. A gesture based input that is particularly unique is to type on an invisible typewriter in front of the player. The sensors have sufficient resolution to make this happen, so data input can be an easier exercise. This expands possible game play and game control options. These examples should not be considered all inclusive, however, and additional uses and gestures are within the scope of this disclosure.

The secondary set of gesture sensors F located in apron J are for more localized gestures and accurate for the sensing of nearby objects such has hands, fingers, thumbs. The same examples apply to this area.

The coarse and fine gestures can be used as input for controlling an avatar, such as an animated character on a screen. In addition, static images or short video clips can be extracted from the video data, and can be displayed on the screen, or together with a player's score, for example.

The embodiments described and illustrated is this document are exemplary and do not limit the scope of the described and claimed invention. For example, one or more video displays B can be provided at different locations within the pinball machine. These displays can vary in size, aspect ratio and projection throw. As another example, the host of sensors C, D, E, F can vary in size or be located in other places on the machine, e.g., at one or more locations along the sides of the playfield.

While there are certain design variations that are common among many pinball machines, layouts for game play elements can be endlessly different. The playfield A shown in FIG. 1 is empty, only because this isn't critical to the disclosure. In addition, this playfield would be populated with game play elements such as, bumpers, switches, plungers, gobble holes, ramps, kickbacks, flippers, giving endless combinations of the gameplay elements. This disclosure therefore is principally directed to gesture, and audio control, of the machine.

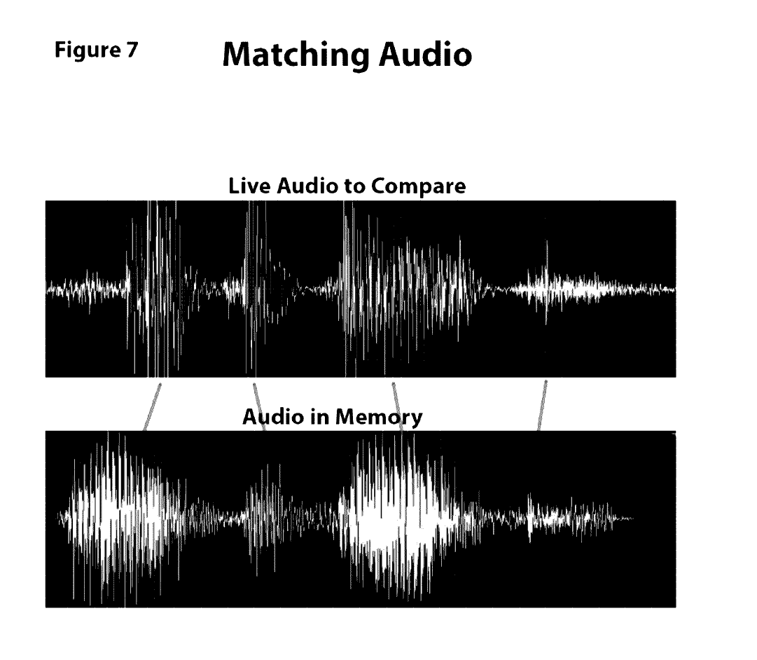

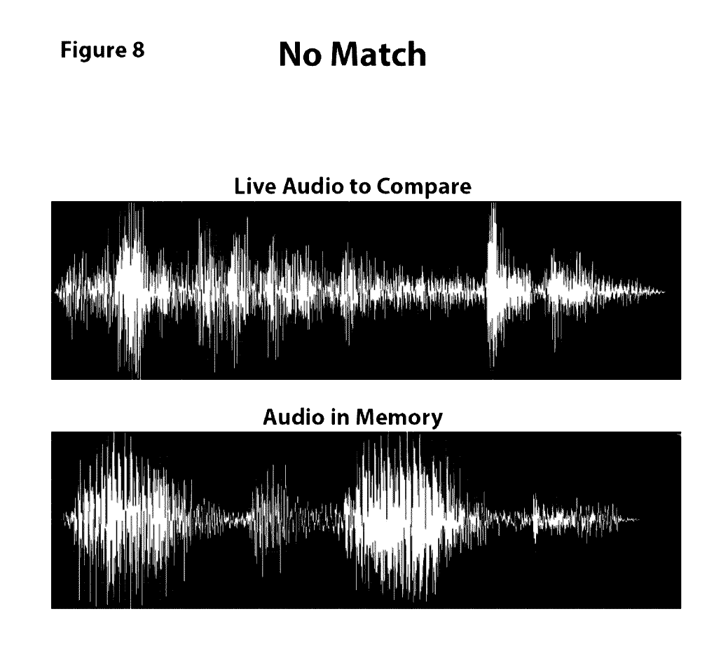

FIG. 7 shows a pair of audio waveforms. The top audio waveform is a live sample of audio, while the audio waveform is a sample that is stored in a library of clips to compare. These two clips are compared using the processing unit, and a match is generated. This match then will guide the gameplay. As an example, the phrase could be “volume up”. If this is the match, then the volume will be increased. Similarly, FIG. 8 shows another pair of audio waveforms where there is no match, and hence would not influence gameplay.

Although the invention has been described in terms of particular embodiments and applications, one of ordinary skill in the art, in light of these teachings, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

It will thus be appreciated that those skilled in the art will be able to devise numerous systems, arrangements and methods which, although not explicitly shown or described herein, embody the principles of the invention and are thus within the spirit and scope of the present disclosure.

1. A pinball machine comprising:
a playfield configured to support a rolling ball and a plurality of game play elements;
a video display associated with the playfield;
a plurality of sensors configured to detect gestures performed by a player;
a processing unit coupled to at least one game play element of the plurality thereof, the video display, and plurality of sensors, the processing unit configured to:
execute gameplay according to game rules and based upon interaction between the rolling ball and the plurality of game play elements,
modify the gameplay based upon the detected gestures, and
cause the video display to display graphics based upon the modification of the gameplay.

2. The pinball machine of claim 1, wherein the processing unit is also configured to modify the game rules based upon the detected gestures and to cause the video to display graphics based upon modification of the game rules.

3. The pinball machine of claim 1, wherein the processing unit is also configured to cause modification of the at least one game play element based upon the detected gestures.

4. The pinball machine of claim 3, wherein modification of the at least one game play element comprises deactivation of that game play element.

5. The pinball machine of claim 3, wherein modification of the at least one game play element comprises movement of that game play element.

6. The pinball machine of claim 1, wherein the graphics displayed on the video display relate to movement of the rolling ball.

7. The pinball machine of claim 1, wherein the graphics displayed on the video display relate to physical contact between the rolling ball and a game play element of the plurality thereof.

8. The pinball machine of claim 1, further comprising a speaker coupled to the processing unit; wherein the plurality of sensors are also configured to detect audio emanating from the player; and wherein the processing unit is also configured to modify the gameplay based upon the audio emanating from the player.

9. The pinball machine of claim 8, wherein the processing unit is also configured to cause the speaker to play sound based upon the modification of the gameplay based upon the audio emanating from the player.

10. The pinball machine of claim 1, further comprising a speaker coupled to the processing unit; wherein the plurality of sensors are also configured to detect audio emanating from the player; and wherein the processing unit is also configured to cause the speaker to play sound based upon the modification of the gameplay based upon the audio emanating from the player.

11. The pinball machine of claim 1, wherein the plurality of sensors are configured to measure distance between the player and the pinball machine; and wherein the processing unit is also configured to modify the gameplay based upon the distance between the player and the pinball machine.

12. The pinball machine of claim 11, wherein the plurality of sensors are configured to measure distance between the player and different portions of the pinball machine; and wherein the processing unit is also configured to modify the gameplay based upon the distance between the player and the different portions of the pinball machine.

13. The pinball game of claim 1, wherein the processing unit is configured to use the plurality of sensors to record video of the user, and to display at least a portion of the recorded video on the video display during the gameplay.

14. The pinball game of claim 1, wherein the plurality of sensors include sensors from the group consisting of: a video sensor, an infrared sensor, a microphone, a proximity sensor, a ranging sensor.

15. The pinball game of claim 1, wherein at least some of the plurality of game play elements are selected from a group comprised of bumpers, switches, plungers, gobble holes, ramps, kickbacks, and flippers.

16. The pinball game of claim 1, wherein the playfield and at least some of the plurality of game play elements are tangible and physical objects.

17. The pinball game of claim 1, further comprising a plurality of ball controlled switches associated with the playfield that are actuated by the rolling ball; and wherein the processor is also configured to modify the gameplay based upon actuation of the plurality of ball controlled switches by moving at least one of the game play elements.

18. The pinball game of claim 17, wherein at least some of the plurality of ball controlled switches are selected from a group comprising proximity sensors, standup switches, rollover switches, and optoelectronic switches.
